(19) United States
(12) Patent Application Publication
(10) Pub. No.: US 2012/0327486 A1
(43) Pub. Date: Dec. 27, 2012

(54) Method and Device of Document Scanning and Portable Electronic Device

(76) Inventors: Chang-Ming Lee, New Taipei City (TW); Kai-Chen Lin, New Taipei City (TW); Chien-An Chen, New Taipei City (TW)

(21) Appl. No.: 13/311,569

(22) Filed: Dec. 6, 2011

(30) Foreign Application Priority Data
Jun. 24, 2011 (TW) 100122242

(51) Int. Cl. H04N 1/387; H04N 1/46

(52) U.S. Cl. 358/505; 358/450

(57) ABSTRACT

The present invention discloses a document scanning method, a document scanning device and a portable electronic device. The document scanning method comprises capturing a plurality of images of a plurality of blocks of a document by an image capturing device; adjusting characteristics of the plurality of images according to distances between the image capturing device and the plurality of blocks when the image capturing device is capturing the plurality of images, to generate a plurality of adjusted images; determining a plurality of characteristic points of each of the plurality of adjusted images and a plurality of characteristic vectors corresponding to the plurality of characteristic points; and combining the plurality of adjusted images according to the plurality of characteristic vectors corresponding to the plurality of characteristic points of each of the plurality of adjusted images, to generate a scanning result of the document.

### BACKGROUND OF THE INVENTION

1. Field of the Invention

The present invention relates to a document scanning method, a document scanning device and a portable electronic device, and more particularly, to a document scanning method, a document scanning device and a portable electronic device combining different images according to characteristic points of images, to provide document scanning function.

2. Description of the Prior Art

Portable electronic devices, e.g. laptops, tablets, smart mobile phones, etc., feature compact size, light weight, and portability, allow a user to have powerful calculating and document processing abilities on the go, and therefore, become one of the essential tools to business people. In such a condition, how to improve functions of the portable electronic devices to meet all kinds of requirements has become one of the goals in the art.

For example, business people usually carry laptops on business trips, to present product information or to record meeting data. However, when a user needs to scan a paper document into an electronic file on occasion, since the user does not carry a scanner in general condition, the user often needs to go to convenient stores nearby or back to office, to scan the paper document. In this situation, the process of scanning the document not only costs money and time but even loses immediacy. Therefore, it will be much more convenient if laptops have document scanning function.

### SUMMARY OF THE INVENTION

Therefore, the present invention mainly provides a document scanning method, a document scanning device and a portable electronic device.

The present invention discloses a document scanning method, comprising capturing a plurality of images of a plurality of blocks of a document by an image capturing device; adjusting characteristics of the plurality of images according to the distance between the image capturing device and the plurality of blocks when the image capturing device is capturing the plurality of images, to generate a plurality of adjusted images; determining a plurality of characteristic points of each of the plurality of adjusted images and a plurality of characteristic vectors corresponding to the plurality of characteristic points; and combining the plurality of adjusted images according to the plurality of characteristic vectors corresponding to the plurality of characteristic points of each of the plurality of adjusted images, to generate a scanning result of the document.

The present invention further discloses a document scanning device, comprising an image capturing device; a distance measuring unit; a processor; and a storage unit, for storing a program code, indicating the processor to execute the following steps: controlling the image capturing device to capture a plurality of images of a plurality of blocks of a document; controlling the distance measuring unit to measure a distance between the image capturing device and the plurality of blocks when the image capturing device is capturing the plurality of images; adjusting characteristics of the plurality of images according to the distance image between the image capturing device and the plurality of blocks when the image capturing device is capturing the plurality of images, to generate a plurality of adjusted images; determining a plurality of characteristic points of each of the plurality of adjusted images and a plurality of characteristic vectors corresponding to the plurality of characteristic points; and combining the plurality of adjusted images according to the plurality of characteristic vectors corresponding to the plurality of characteristic points of each of the plurality of adjusted images, to generate a scanning result of the document.

The present invention further discloses a portable electronic device, comprising a processor; a storage unit; an image capturing device; and a document scanning device, comprising a distance measuring unit; a program code, storing in the storage unit, indicating the processor to execute the following steps: controlling the image capturing device to capture a plurality of images of a plurality of blocks of a document; controlling the distance measuring unit to measure a distance between the image capturing device and the plurality of blocks when the image capturing device is capturing the plurality of images; adjusting characteristics of the plurality of images according to the distance image between the image capturing device and the plurality of blocks when the image capturing device is capturing the plurality of images, to generate a plurality of adjusted images; determining a plurality of characteristic points of each of the plurality of adjusted images and a plurality of characteristic vectors corresponding to the plurality of characteristic points; and combining the plurality of adjusted images according to the plurality of characteristic vectors corresponding to the plurality of characteristic points of each of the plurality of adjusted images, to generate a scanning result of the document.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a document scanning device according to an embodiment of the present invention.

FIG. 2 illustrates a schematic diagram of Hessian Matrix according to an embodiment of the present invention.

FIG. 3 illustrates a schematic diagram of a document scanning process according to an embodiment of the present invention.

### DETAILED DESCRIPTION

Portable electronic devices, e.g. laptops, tablets, smart mobile phones, etc., are usually equipped with cameras, to provide image capturing functions, e.g. taking photos, photographing, performing video telephone. In such a condition, the present invention utilizes an image capturing function of a portable electronic device to achieve a scanning function, and further uses a series of processing procedures to effectively combine different image parts of a document into a complete document or image data.

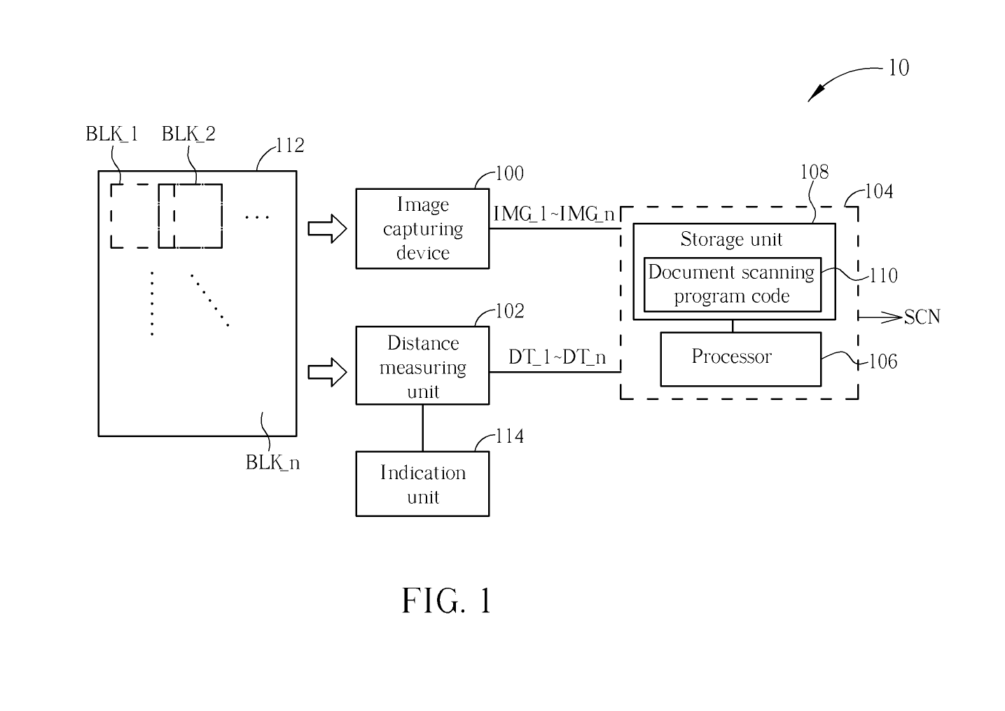

Please refer to FIG. 1, which illustrates a schematic diagram of a document scanning device 10 according to an embodiment of the present invention. The document scanning device 10 can be implemented in a portable electronic device, e.g. a laptop, a tablet, a smart phone, and comprises an image capturing device 100, a distance measuring unit 102, an indication unit 114 and a processing module 104. The image capturing device 100 can be a camera or video device originally equipped in the portable electronic device, and is utilized for capturing images. The distance measuring unit 102 applies infrared or supersonic distance measuring principle to measure a distance between the image capturing device 100 and an image when the image capturing device is capturing the image. The indication unit 114 shows distance measuring results generated by the distance measuring unit 102 by lights, sounds or messages displayed on a screen, for example. The processing module 104 comprises a processor 106 and a storage unit 108. The storage unit 108 stores a document scanning program code 110, for indicating the processor 106 to execute a document scanning function.

When performing the document scanning function, the document scanning device 10 uses the image capturing device 100 to capture images IMG_{—}1-IMG_n of blocks BLK_{—}1-BLK_n of a document 112 to be scanned. When the image capturing device 100 is capturing the images IMG_{—}1-IMG_n, the distance measuring unit 102 measures distances DT_{—}1-DT_n between the image capturing device 100 and the blocks BLK_{—}1-BLK_n, and displays corresponding measuring results via the indication unit 114. The processing module 104 first adjusts characteristics of the images IMG_{—}1-IMG_n according to the distances DT_{—}1-DT_n, determines characteristic points and characteristic vectors thereof, and finally combines the adjusted images accordingly, so as to generate a scanning result SCN of the document 112.

The following illustrates the processing principles of the processing module 104 particularly in different steps.

### Image Adjusting:

As mentioned in the above, the image capturing device 100 can be a camera originally equipped in the portable electronic device or an additional device. Since the available space of the portable electronic device is small, to maintain quality of image capturing, the document scanning device 10 sequentially captures images of different blocks BLK_{—}1-BLK_n of the document 112. Note that, adjacent blocks within the blocks BLK_{—}1-BLK_n should have some overlapped part, such that the document scanning device 10 can accurately combine the images. How to combine images and how to react when images cannot be combined will be discussed later. Besides, it is preferred to manually shift the document 112 by a user when capturing the images IMG_{—}1-IMG_n of the blocks BLK_{—}1-BLK_n, but is not limited thereto. Furthermore, to ensure the way the user shifts the document 112 complies with system requirements, the indication unit 114 can inform the user of a best distance, so as to avoid irregular sizes of the images IMG_{—}1-IMG_n.

As can be seen, when scanning the document 112, the user shifts the document 112 in front of the image capturing device 100, and the image capturing device 100 continuously captures the images IMG_{—}1-IMG_n of the blocks BLK_{—}1-BLK_n. Since the user manually shifts the document 112, the distances between the image capturing device 100 and the document 112 may be different when capturing the images IMG_{—}1-IMG_n, such that the sizes of the images IMG_{—}1-IMG_n are different, which may cause an obvious block difference or a level difference in a combined document image. Therefore, the perpendicular distance between the document 112 and the image capturing device 100 is important, affecting the definition of the captured contents whenever too far or too close. In such a condition, when the user is performing scanning, the distance measuring unit 102 can indicate the user the best distances between the image capturing device 100 and each block of the document 112 through the indication unit 114.

Besides, when the image capturing device 100 is capturing the images IMG_{—}1-IMG_n, the distance measuring unit 102 simultaneously records the perpendicular distances DT_{—}1-DT_n between the blocks BLK_{—}1-BLK_n and the image capturing device 100. The distances DT_{—}1-DT_n become important reference data for adjusting magnitude, sharpness, contrast of each image, when combining the images IMG_{—}1-IMG_n of the blocks BLK_{—}1-BLK_n. Meanwhile, if the processing module 104 detects quality of an image of a block of the document 112 is poor or cannot be combined, the processing module 104 may suggest the user to re-capture the image of the block. As a result, the contents of the combined images are more identical, and the quality of the scanning result is better.

Therefore, when acquiring the images IMG_{—}1-IMG_n, the processing module 104 records the distances DT_{—}1-DT_n between the corresponding blocks BLK_{—}1-BLK_n and the image capturing device 100 as references of adjusting/zooming the images IMG_{—}1-IMG_n. There are several ways to adjust the images IMG_{—}1-IMG_n; for example, a benchmark of a zoom criterion can be an average of distances (e.g. DT_{—}2, DT_{—}4) when the image capturing device 100 is capturing even blocks (i.e. BLK_{—}2, BLK_{—}4). For example, if the image capturing device 100 captures images IMG_{—}1-IMG_{—}4 of blocks BLK_{—}1-BLK_{—}4, a distance DT_{—}2 is 2 cm, and a distance DT_{—}4 is 3 cm, such that a zoom criterion is the mean of DT 2 and DT_{—}4, which is 2.5 cm. Therefore, the second image IMG_{—}2 needs to magnitude 2/2.5=0.8 times, and the fourth image IMG_{—}4 needs to magnitude 3/2.5=1.2 times.

In addition, the algorithm of zooming process can be bilinear interpolation. After all of the captured images are adjusted to the same level, the processing module 104 performs combining the block images of the document 112.

### Image Combining:

The basic concept of image combining is to find the same image contents between adjacent images, and to combine images accordingly. In order to determine image contents, the processing module 104 needs to select representative characteristic points. There are several forms of image characteristics, such as grain, color, shape, contour, etc., and the present invention finds representative corner point features to represent the images.

(a) Finding Characteristic Points:

In order to determine the corner point features, the processing module 104 first utilizes an integral image technique to accelerate the operation, and utilizes quantized second order partial derivative Gauss equation to calculate determinants of Hessian matrixes of the images, and finally generates Hessian matrixes corresponding to different variances σ, to find the characteristic points.

In detail, if I(x,y) denotes a pixel at a coordinate (x,y) of an image I, under the circumstance that a variance is σ, Hessian matrix of coordinate (x,y) is denoted by

$$h ( x , y , σ ) = [ \begin{matrix}{L}_{xx} ( x , y , σ ) & {L}_{xy} ( x , y , σ ) \\ {L}_{xy} ( x , y , σ ) & {L}_{yy} ( x , y , σ )\end{matrix} ] ,$$

wherein h(x,y,σ) is the Hessian matrix corresponding to the pixel I(x,y); Lₓₓ(x, y,σ) is a convolution of the pixel I(x,y) and second order derivatives

$$\frac{{\partial }^{2}}{\partial {x}^{2}} g ( σ )$$

on the x-coordinate of Gauss equation g(σ); L_{xy}(x,y,σ) and L_{yy}(x,y,σ) are convolutions of the pixel I(x,y) and

$$\frac{{\partial }^{2}}{\partial xy} g ( σ ) ,$$

and the pixel I(x,y) and

$$\frac{{\partial }^{2}}{\partial {y}^{2}} g ( σ )$$

respectively; and g(σ) is Gauss equation. Each element H(x,y,σ) is a determinant of a Hessian matrix of the image I at coordinate (x,y), and can be written as H(x,y,σ)=Lₓₓ(x,y,σ)*L_{yy}(x,y,σ)−(L_{xy}(x,y,σ))², where H is called Hessian matrix of the image I corresponding to the variance σ. Utilizing different values of σ, the processing module 104 acquires different Hessian matrixes H; for example, selecting σ₁=1.2, σ₂=2 and σ₃=2.8, H₁, H₂ and H₃ under different scale spaces can be obtained. After Hessian matrixes of the image I corresponding to different σ are generated, the processing module 104 searches characteristic points from the Hessian matrixes.

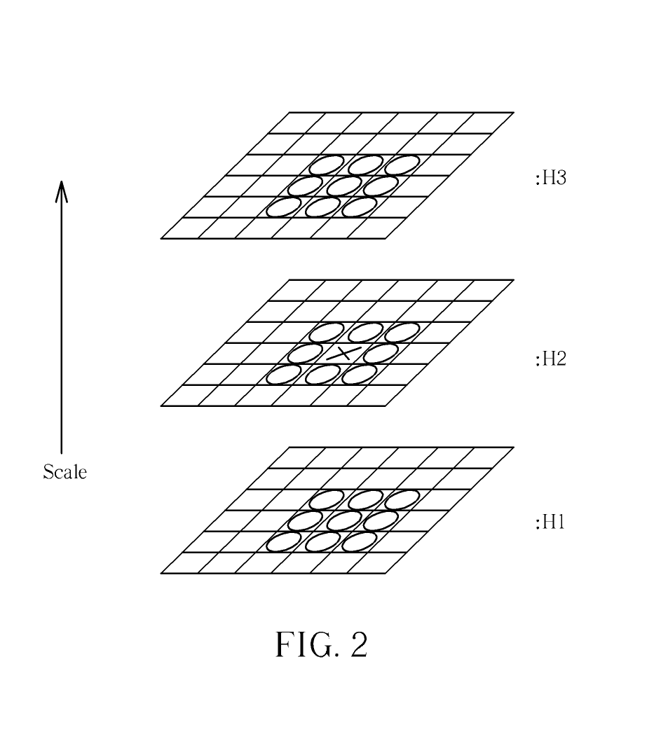

Assume there are a pixel at coordinate (x,y), i.e. a point X shown in FIG. 2, and H₁, H₂ and H₃ are Hessian matrixes corresponding to σ₁, σ₂ and σ₃, as shown in FIG. 2, then 26 adjacent pixels of the point X (9 adjacent pixels for each of up and down scales plus 8 adjacent pixels for its own scale) are denoted as the circle points shown in FIG. 2. If the point X has maximum determinant of Hessian matrix within the 26 adjacent pixels, the point X is called a characteristic point.

(b) Determining Characteristic Vectors:

After determining the characteristic point, since a single characteristic point cannot precisely describe data adjacent to the characteristic point, the processing module 104 needs to divide an adjacent area around the characteristic point, and utilize the adjacent area to generate a characteristic vector representing the characteristic point. First, the processing module 104 has to find a main direction of the characteristic vector before calculating and describing the characteristic vector of a characteristic point X, to make the characteristic vector immune from rotation, i.e. after images are rotated, the processing module 104 can effectively find characteristic points within two images. Therefore, the processing module 104 marks out a square area R including pixels (e.g. 20*20) around a center of the characteristic point X, and performs convolution on the area R with Haar horizontal filter and Haar vertical filter, respectively. The convolution results are denoted by dx(x,y) and dy(x,y), which are matrixes with the same scale with the area R (e.g. 20*20). Thus, each of pixel in the area R has a corresponding value in dx(x,y) and dy(x,y).

Then, defining the characteristic point X as center and from 0 degree to 60 degree as an area, the processing module 104 calculates a sum of the corresponding values of dx(x,y) and dy(x,y) of each pixel in the 0-60-degree area, to acquire an order pair (i.e. (Σdx(x,y), Σdy(x,y))). The order pair is denoted as a vector, whose length, i.e. L={square root over ((Σdx(x,y))²+Σdy(x,y))²)}, represents a length of the 0-60-degree area of the center point X. Then, the processing module 104 respectively calculates the lengths of 60-120-degree, 120-180-degree, 180-240-degree, 240-300-degree, and 300-360-degree areas. Assuming the length of the 60-120-degree area is the longest length among the acquired lengths, the main direction of the characteristic point X is defined as 90 degree, i.e. (120+60)/2. In this embodiment, 60-degree is used as an interval to divide the area R, but smaller degree can also be used as the interval in practical application, to find more accreted direction. In other words, the degree range of interval affects the accuracy of acquiring the main direction of characteristic point.

After acquiring the main direction of the characteristic point X, the processing module 104 rotates the image till the main direction of the characteristic point X is the north, and marks out a new area R′, wherein the area R′ is also a square area (i.e. 20*20) around the center of the characteristic point X, in order to generate a characteristic vector immune from rotation and denoted by dx′(x,y), dy′(x,y), wherein dx′(x,y), dy′(x,y) are matrixes whose scales are the same with the scale of the area R′.

Then, the processing module 104 divides the area R′ into a plurality of sub-blocks, such as 4*4 sub-blocks each having a scale of 5*5, and utilizes dx′(x,y) dy′(x,y) and to calculate four components (Σdx′(x,y), Σdy′(x,y), Σ|dx′(x,y)|, Σ|dy′(x,y)|) for each sub-block, to represent the corresponding sub-blocks. In this example, since the area R′ has 4*4 sub-blocks and each sub-block has four components, the processing module 104 can define the main direction of the characteristic point X as a criterion, and respectively combine each of four components representing each sub-block from left to right and from up to down, to form a 64-scale characteristic vector, for representing the characteristic point X.

(c) Image Comparing and Combining:

When comparing two images, the processing module 104 determines characteristic points in the two images, generates characteristic vectors of each characteristic point by the method of (b), and compares the characteristic vectors of the characteristic points to acquire the most correlated characteristic point. The method of comparing is shown as follows, if X is a characteristic point, in the procedure of comparing characteristic points, the processing module 104 calculates Euclidean distance between the character point X and another characteristic point according to the characteristic vectors thereof. Assume that characteristic points X1 and X2 are the first closest and the second closest characteristic points of the characteristic point X respectively, and the Euclidean distances between X and X1, X2 are d1, d2 respectively. If d1<r*d2, x1 is determined as the most correlated to X, wherein r is a custom coefficient, e.g. 0.5. Finally, superposing two closest characteristic points to complete the combination of two images, and this is the reason why an overlapped part between two adjacent images is needed.

(d) Color Converting:

Before determining characteristic points, the present invention can further pre-process each block image, to classify similar colors in the image into the same kind of colors by quantization, so as to acquire characteristics of all fields more effectively. The main objective is to let two similar images to be classified into the same category, to reduce the situation that the two similar images are classified into different categories because of color difference caused by slight light differences when combining images. There are many methods to achieve color converting; for example, the processing module 104 can covert image from RGB color space to CIEL*a*b* color space first, quantize two sub-bands a* and b* of CIEL*a*b* color space, and finally convert the image from CIEL*a*b* color space to RGB color space.

The objective of color quantization is to reduce the difference between colors of the image, which means the similar colors are normalized into the same color. In order to acquire ideal accuracy and efficiency when scanning a document, selection of characteristics has to require the stability of extracting characteristics or comply with requirements of processing speed. Therefore, the principle of selecting characteristics is to clearly indicate differences between characteristics when the differences between images of blocks are greater, and on the contrary, to ignore differences or make differences unobvious when the differences between images of blocks are slight. In such a condition, simply utilizing the above-mentioned corner point characteristic cannot distinguish images with high accuracy, therefore the processing module 104 requires more additional characteristics to describe details of the images, to combine with the above characteristic to characteristic vectors representing the images. For example, Sobel edging characteristic, invariant moment, standard deviation of RGB color, and mean characteristic can be combined with the corner point characteristic into a characteristic vector as reference of combining images, wherein the scales of each characteristic vector of each image are the same. In other words, the present invention can acquire a characteristic point by the above method (a), define the characteristic point as a center and circle a square area (i.e. 15*15) around the center, calculate a Sobel characteristic (225 scale), seven invariant moment characteristics (7 scale), and RGB color characteristic (6 scale) of the square area, and finally acquire a 238 scale characteristic vector.

After adding operations of color converting, the operation methods of comparing and combining related images are referred to the above method of (c), and are not narrated hereinafter for simplicity.

(e) Debugging:

During the operation process of combining, if there is an image whose characteristic points cannot be combined with other characteristic points of other images, or the correlated characteristic points are less than a default value (e.g. 20), then the document scanning device 10 of the present invention can warn the user via the indication unit 114, ask the user to re-capture images of the corresponding blocks of the document 112, find characteristic vectors and characteristic points of the re-captured images, and combine with other combined parts.

Therefore, as can be seen from the above, the document scanning device 10 of the present invention divides the document 112 into the blocks BLK_{—}1-BLK_n for capturing, and finally combines images into the scanning result SCN by a sequence of algorithms. Meanwhile, if combination fails, the document scanning device 10 can effectively debug, to insure accuracy of the scanning result SCN.

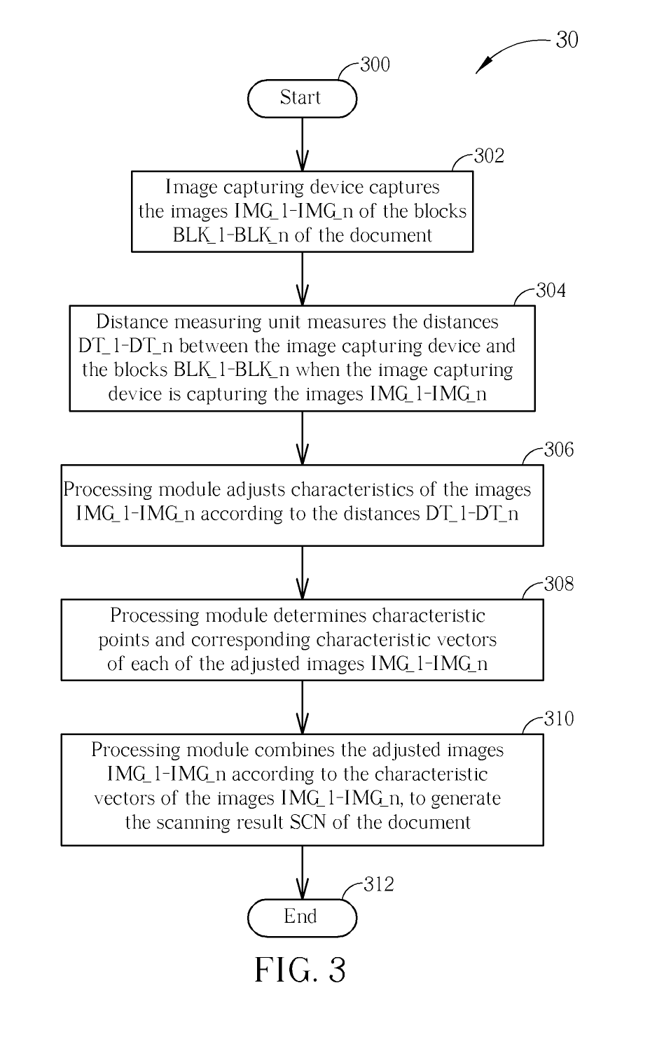

Operations of the document scanning device 10 can further be summarized into a document scanning process 30 as shown in FIG. 3. The document scanning process 30 comprises:

Step 300: Start.

Step 302: The image capturing device 100 captures the images IMG_{—}1-IMG_n of the blocks BLK_{—}1-BLK_n of the document 112.

Step 304: The distance measuring unit 102 measures the distances DT_{—}1-DT_n between the image capturing device 100 and the blocks BLK_{—}1-BLK_n when the image capturing device is capturing the images IMG_{—}1-IMG_n.

Step 306: The processing module 104 adjusts characteristics of the images IMG_{—}1-IMG_n according to the distances DT_{—}1-DT_n.

Step 308: The processing module 104 determines characteristic points and corresponding characteristic vectors of each of the adjusted images IMG_{—}1-IMG_n.

Step 310: The processing module 104 combines the adjusted images IMG_{—}1-IMG_n according to the characteristic vectors of the images IMG_{—}1-IMG_n, to generate the scanning result SCN of the document 112.

Step 312: End.

The document scanning process 30 is a summary of the operations of the document scanning device 10, and the detailed operations or alterations, such as determining characteristic points and characteristic vectors, debugging mechanism, can be referred to the above description. Besides, in the document scanning device 10, all operating principles are compiled into the document scanning program code 110, which is a well-known skill for those skilled in the art. Noticeably, the document scanning program code 110 is not limited to be any programming language as long as the programming language can be executed by the processor 106 to achieve corresponding functions.

Moreover, elements of the document scanning device 10 are basic components to realize the present invention. However, according to different system requirements, the elements can be originally equipped in the system and converted to realize the present invention. For example, CPU, memory, and camera originally equipped in a portable electronic device, e.g. laptop, smart mobile phone, etc., can be used to achieve the processor 106, the storage 108 and the image capturing device 100 of the document scanning device 10. Similarly, the distance measuring unit 102 can be realized by Proximity Sensor, and the indication unit 114 can be realized by a message window shown on a screen or a beep from speakers. In other words, when the document scanning device 10 is applied to the portable electronic device, the portable electronic device may only need to add the document scanning program code 110 to realize corresponding functions, such that the user may be much willing to apply the document scanning device 10.

In the prior art, when a paper document needs to be scanned into an electric file on occasion, since the user of a laptop does not carry a scanner in the normal situation, the user can either go to a nearby convenience store or go back to office to scan the paper document, which not only costs time and money but loses the immediacy. In such a situation, the present invention provides a document scanning function for the portable electronic device, to effectively improve convenience.

To sum up, the present invention combines different images according to characteristic points of the images, so as to provide a document scanning function for a portable electronic device and to improve functionality and convenience of the portable electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A document scanning method, comprising:
capturing a plurality of images of a plurality of blocks of a document by an image capturing device;
adjusting characteristics of the plurality of images according to distances between the image capturing device and the plurality of blocks when the image capturing device is capturing the plurality of images, to generate a plurality of adjusted images;
determining a plurality of characteristic points of each of the plurality of adjusted images and a plurality of characteristic vectors corresponding to the plurality of characteristic points; and
combining the plurality of adjusted images according to the plurality of characteristic vectors corresponding to the plurality of characteristic points of each of the plurality of adjusted images, to generate a scanning result of the document.

2. The document scanning method of claim 1, wherein the characteristics of the plurality of image are selected from magnification, sharpness, contrast and chrominance.

3. The document scanning method of claim 1, wherein the step of determining the plurality of characteristic points of each of the adjusted images and the plurality of characteristic vectors corresponding to the plurality of characteristic points comprises:
calculating a plurality of Hessian matrixes of each pixel of each of the adjusted images corresponding to a plurality of variance;
selecting the plurality of characteristic points from the plurality of pixels according to Hessian matrixes of the plurality of pixels of each of the adjusted images;
calculating Haar operation results of a plurality of adjacent pixels of each of the characteristic points; and
determining the plurality of characteristic vectors according to the Haar operation results of the plurality of adjacent pixels of each of the plurality of characteristic points.

4. The document scanning method of claim 1, wherein the step of combining the plurality of adjusted images according to the plurality of characteristic vectors of each of the plurality of adjusted images, to generate the scanning result, comprises:
comparing the plurality of characteristic vectors of each of the plurality of adjusted images, to determine similar characteristic points within the plurality of adjusted images; and
combining the plurality of adjusted images sequentially based on the similar characteristic points within the plurality of adjusted images, to generate the scanning result of the document.

5. The document scanning method of claim 4, further comprising capturing images of a block corresponding to an adjusted image of the plurality of adjusted images when there is no similar characteristic point between the adjusted image and other adjusted images of the plurality of adjusted images.

6. A document scanning device, comprising:
an image capturing device;
a distance measuring unit;
a processor; and
a storage unit, for storing a program code, which instructs the processor to execute the following steps:
controlling the image capturing device to capture a plurality of images of a plurality of blocks of a document;
controlling the distance measuring unit to measure a distance between the image capturing device and the plurality of blocks when the image capturing device is capturing the plurality of images;
adjusting characteristics of the plurality of images according to the distance between the image capturing device and the plurality of blocks when the image capturing device is capturing the plurality of images, to generate a plurality of adjusted images;
determining a plurality of characteristic points of each of the plurality of adjusted images and a plurality of characteristic vectors corresponding to the plurality of characteristic points; and
combining the plurality of adjusted images according to the plurality of characteristic vectors corresponding to the plurality of characteristic points of each of the plurality of adjusted images, to generate a scanning result of the document.

7. The document scanning device of claim 6, wherein the characteristics of the plurality of image are selected from magnification, sharpness, contrast and chrominance.

8. The document scanning device of claim 6, wherein the step of determining a plurality of characteristic points of each of the plurality of adjusted images and a plurality of characteristic vectors corresponding to the plurality of characteristic points comprises:
calculating a plurality of Hessian matrixes of each pixel of each of the adjusted images corresponding a plurality of variance;
selecting the plurality of characteristic points of the plurality of pixels according to Hessian matrixes of the plurality of pixels of each of the adjusted images;
calculating Haar operation results of a plurality of adjacent pixels of each of the characteristic points; and
determining the plurality of characteristic vectors according to the Haar operation results of the plurality of adjacent pixels of each of the plurality of characteristic points.

9. The document scanning device of claim 6, wherein the step of combining the plurality of adjusted images according to the plurality of characteristic vectors of each of the plurality of adjusted images, to generate the scanning result, comprises:
comparing the plurality of characteristic vectors of each of the plurality of adjusted images, to determine a similar characteristic points within the plurality of adjusted images; and
combining the plurality of adjusted images sequentially based on the similar characteristic points within the plurality of adjusted images, so as to generate the scanning result of the document.

10. The document scanning device of claim 9, further comprising capturing images of a block corresponding to an adjusted image of the plurality of adjusted images when there is no similar characteristic point between the adjusted image and other adjusted images of the plurality of adjusted images.

11. The document scanning device of claim 6, further comprising an indication unit, wherein the program code further instructs the processor to indicate the user to shift the document via the indication unit, to have the image capturing device sequentially capture the plurality of images of the plurality of blocks.

12. A portable electronic device, comprising:
a processor;
a storage unit;
an image capturing device; and
a document scanning device, comprising:
a distance measuring unit;
a program code, stored in the storage unit, for instructing the processor to execute the following steps:
controlling the image capturing device to capture a plurality of images of a plurality of blocks of a document;
controlling the distance measuring unit to measure a distance between the image capturing device and the plurality of blocks when the image capturing device is capturing the plurality of images;
adjusting characteristics of the plurality of images according to the distance image between the image capturing device and the plurality of blocks when the image capturing device is capturing the plurality of images, to generate a plurality of adjusted images;
determining a plurality of characteristic points of each of the plurality of adjusted images and a plurality of characteristic vectors corresponding to the plurality of characteristic points; and
combining the plurality of adjusted images according to the plurality of characteristic vectors corresponding to the plurality of characteristic points of each of the plurality of adjusted images, to generate a scanning result of the document.

13. The portable electrical device of claim 12, wherein the characteristics of the plurality of images are selected from magnification, sharpness, contrast and chrominance.

14. The portable electrical device of claim 12, wherein the step of determining the plurality of characteristic points of each of the plurality of adjusted images and the plurality of characteristic vectors corresponding to the plurality of characteristic points comprises:
calculating a plurality of Hessian matrixes of each pixel of each of the adjusted images corresponding to a plurality of variance;
selecting the plurality of characteristic points from the plurality of pixels according to Hessian matrixes of the plurality of pixels of each of the adjusted images;
calculating Haar operation results of a plurality of adjacent pixels of each of the characteristic points; and
determining the plurality of characteristic vectors according to the Haar operation results of the plurality of adjacent pixels of each of the characteristic points.

15. The portable electrical device of claim 12, wherein the step of combining the plurality of adjusted images according to the plurality of characteristic vectors of each of the plurality of adjusted images, to generate the scanning result, comprises:
comparing the plurality of characteristic vectors of each of the plurality of adjusted images, to determine a similar characteristic points within the plurality of adjusted images; and
combining the plurality of adjusted images sequentially based on the similar characteristic points within the plurality of adjusted images, so as to generate the scanning result of the document.

16. The portable electrical device of claim 15, further comprising capturing images of a block corresponding to an adjusted image of the plurality of adjusted images when there is no similar characteristic point between the adjusted image and other adjusted images of the plurality of adjusted images.

17. The portable electrical device of claim 12, further comprising an indication unit, wherein the program code further instructs the processor to indicate the user to shift the document via the indication unit, to have the image capturing device sequentially capture the plurality of images of the plurality of blocks.
